(19) United States
(12) Patent Application Publication
(10) Pub. No.: US 2026/0168214 A1
(43) Pub. Date: Jun. 18, 2026

(54) SYSTEM AND METHOD FOR DRILLING SLANT WELLS

(71) Applicant: Corey Boaz, Salem, OR (US)

(72) Inventor: Corey Boaz, Salem, OR (US)

(21) Appl. No.: 19/386,158

(22) Filed: Nov. 11, 2025

Related U.S. Application Data
(60) Provisional application No. 63/719,609, filed on Nov. 12, 2024.
(60) Provisional application No. 63/726,595, filed on Dec. 1, 2024.

(51) Int. Cl. E03B 3/14; E03B 3/26

(52) U.S. Cl. CPC E03B 3/14; E03B 3/26

(57) ABSTRACT

The present invention is directed to the construction and use of slant wells, combining the use of louvered casing, auger drilling, gravel packing, and other elements to provide an ability to drill slant wells near freshwater and saltwater sources for reliable water extraction. The filtration methods of the present invention provide clean, uncontaminated drinking water free of sediment using reverse osmosis and other filtration methods. The slant wells are positioned within the water table underneath the ocean floor. The angled drilling allows the well casing to be positioned further from the shoreline, significantly reducing the risk of exposure or damage. The diagonal design maximizes water access by extending the well screen horizontally within the aquifer. Once aquifer dimensions are established, the slant wells are engineered for optimal efficiency, with adjustable angles based on each site.

### CROSS REFERENCE TO RELATED APPLICATIONS

This application claims the benefit of U.S. Provisional Patent Application No. 63/719,609, filed Nov. 12, 2024, and U.S. Provisional Patent Application No. 63/726,595, filed Dec. 1, 2024, the contents of which are incorporated herein by reference.

### BACKGROUND OF THE INVENTION

The present invention is directed to the construction and use of slant wells. The present invention provides an ability to pull and filter water from freshwater and saltwater sources in order to provide drinkable, clean water. The present invention provides a novel filtration system comprising the construction of a “filter package” capable of removing contaminants that are capable of flowing through traditional well filter screens.

Securing access to clean water is a worldwide problem. Globally, over two billion people lack access to safely managed drinking water services. Millions of people lack reliable access to clean drinking water and face intermittent water supply, especially in rural and low-income areas. Current environmental and infrastructure challenges include climate change causing erratic rainfall and increasing drought, with aging infrastructure causing water loss due to leaks and poor maintenance. Communities need additional water sources, and new methods to secure clean drinking water. Previous attempts at drilling slant wells have been unsuccessful in their ability to create wells with substantial diameter due to the limitations presented when drilling at an angle. The present invention provides a solution to this issue by combining drill techniques including the use of augers. Overall, this leads to a novel ability to increase the flow rate provided by a slant well.

### SUMMARY OF THE INVENTION

The present invention pertains to a system and method for drilling slant wells. In the preferred embodiment of the present invention, a well casing is installed at an angle below a water source. The water source may be freshwater or saltwater. The water source may comprise of a lake, a pond, a river, an ocean, or any other body of freshwater or saltwater. Once the outer conductor casing is installed, a well casing is installed in the center of the outer conductor casing, then a unique combination of gravel is inserted into the hallow cavity between the outer conductor casing and the well casing. Once the gravel has been sufficiently packed in, the outer conductor casing is removed, leaving a packed column of gravel with a well casing inside of the gravel column in its place. This provides an ability to filter water in the area surrounding the well casing.

The present invention pertains to a slant well to procure water from under the ocean water table. The proprietary design of the slant well allows for a more economical and efficient intake of water, with far fewer environmental impacts than a traditional direct sea intake. Traditionally, coastal communities across the world have relied on existing aquifers to extract both salt and fresh water. Due to diminishing aquifers, this process has become much less reliable. The present invention describes slant wells that can procure water from the water table located under the ocean. The extracted water is then purified at a reverse osmosis (RO) plant. By not relying on aquifers to refill, the slant wells of the present invention have an unlimited recharge source via the ocean.

In order to increase the flow rate of water through the slant well, the present invention combines drilling techniques wherein an auger is placed within the outer conductor casing in order to push material out of the way while simultaneously advancing the outer conductor casing forward. This provides an ability to increase the diameter of the outer conductor casing and thus increase the diameter of the packed gravel within the outer conductor casing, leading to a higher flow rate of water through the well.

The present invention may make use of reverse osmosis in order to ensure the water pulled from the well is thoroughly filtered. Reverse osmosis is a water purification process wherein water is forced through a semipermeable membrane from an area of high concentration of contaminants to an area of low concentration of contaminants. Water that is pushed through the membrane may be referred to as the permeate, and the contaminants left behind may be referred to as the waste or brine. Following filtration, whether by reverse osmosis or other means, the present invention ensures that essential minerals are added back to the filtered water.

The present invention may make use of centralizers. Centralizers are devices used to prevent casing from touching the sides of the borehole, or the hole made in the ground to extract water. In the present invention, centralizers may be used in connection with the well casing in order to fulfill such a purpose. The present invention may also use louvered casing to allow the flow of water without small sediment and contaminants.

Unlike traditional vertical wells that struggle in thin aquifers, the present invention's innovative diagonal design maximizes water access by extending the well screen horizontally within the aquifer. Once aquifer dimensions are established, the slant wells are engineered for optimal efficiency, with adjustable angles ranging from 5 to 35 degrees to perfectly suit each unique site. Before installation, the site is evaluated by using electrical resistivity studies to determine if the sub surface conditions will work for the slant wells. If slant wells are not viable in the tested location, the present invention's slant wells can be designed and built to be directionally drilled, with open intakes that also mitigate environmental impacts.

The present invention is a long-term sustainable solution for reliable water extraction. In one embodiment, the slant wells provide efficient, intense weather-resistant water access. Positioned within the water table underneath the ocean floor, the slant wells tap into a virtually infinite water source. The present invention's process enables the installation of a large volume filter pack around the well screen, ensuring long-term performance. The angled drilling allows the well casing to be positioned further from the shoreline, significantly reducing the risk of exposure or damage during major storm events.

The present invention is an environmentally friendly solution. Water is our most precious resource, and protecting oceans and marine life is central to the approach of the present invention. By design, the present invention's slant wells remain outside of the ocean, thereby avoiding harm to marine ecosystems and reefs. Additionally, drilling takes place well away from the shore, preventing any disturbance to beaches and minimizing environmental impact. Without reliable water sources, communities cannot effectively grow. To adapt to climate change, exploring alternative water sourcing methods is essential. By installing the present invention's slant wells, pressure is alleviated on freshwater aquifers, allowing them the opportunity to naturally replenish. In connection with slant well installations, the present invention is also dedicated to delivering several hundred thousand gallons of clean water daily to local areas in need.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIGS. 1A-B show the centralizers in relation to the casing of the present invention.

FIG. 2 shows the slant well as drilled.

FIGS. 3A-B shows cross-sectional views of the well casing, outer conductor casing, and borehole.

FIG. 4 is a diagram of the present invention.

FIG. 5 is a diagram of the well cross section of present invention.

FIG. 6 is a diagram of the electrical resistivity survey results of the present invention.

### DETAILED DESCRIPTION OF THE PREFERRED EMBODIMENT

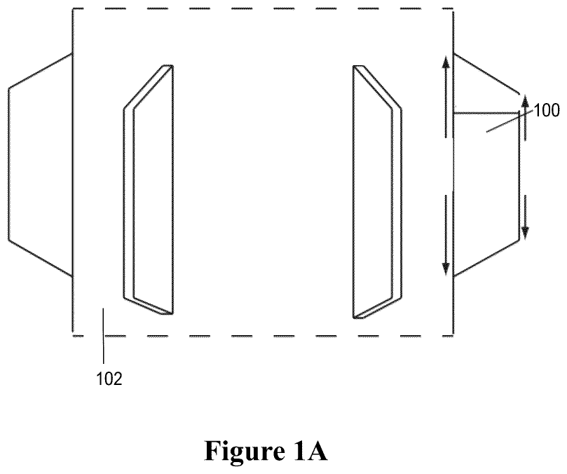

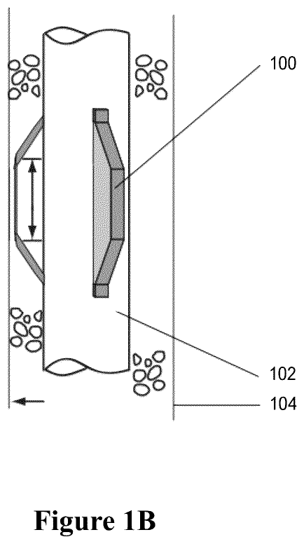

FIGS. 1A-B show the centralizers in relation to the casing of the present invention. In accordance with the preferred embodiment of the present invention, sets of casing centralizers are installed at the bottom of the well casing at a desired spacing, for example every 10-20 feet, along the louvered casing and at the top of the louvered casing. The centralizers should be installed at the casing section collars but may be installed adjacent to the louvers in alternative embodiments. The preferred material used for the centralizers is 2205 steel, though the present invention contemplates the use of other similar materials. Centralizers should be trapezoidal in shape, where the base of the trapezoid is installed against the well casing. In the preferred embodiment, centralizers 100 are installed in sets of four and are equally spaced. Centralizers 100 should be evenly spaced around the well casing 102 as well as evenly along the well casing 102. For example, and not by way of limitation, centralizers 100 may be located every 10-20 ft along the well casing 102, and every 60° around the circumference of the well casing 102.

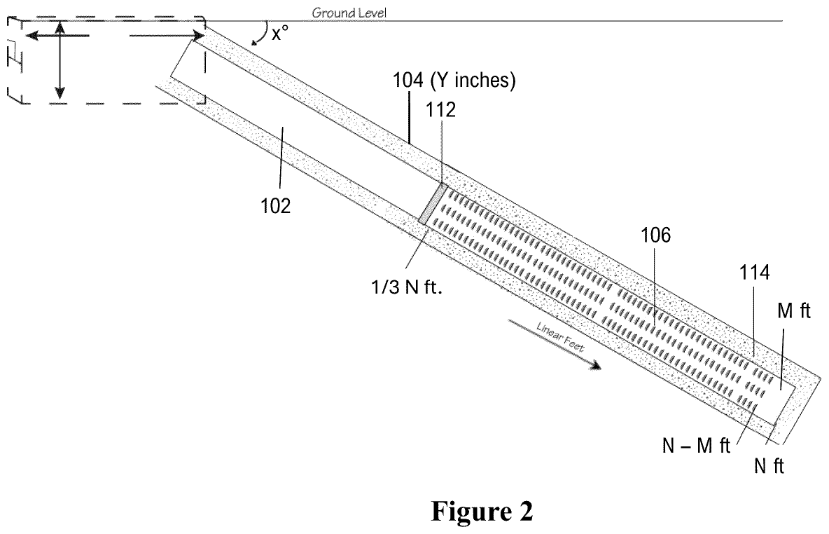

FIG. 2 shows the slant well as drilled. In accordance with the preferred embodiment of the present invention, the well is drilled at an angle X° from ground level into a pre-specified subterranean zone. The louvered casing 106 extends N ft into the ground at angle X°. The louvers end approximately M ft before the end of the louvered casing 106. The spine lock coupling 112 is located approximately ⅓ N ft from the ground. The outer conductor casing 104 is filled with the gravel pack 114, which surrounds the louvered casing 106 and the well casing 102. In the preferred embodiment, the well pulls ground water from the surrounding area through the louvered casing 106. An additional screen within the louvered casing 106 filters out small sediment and contaminants. The present invention provides an increased flow rate compared to traditional methods by combining drilling techniques wherein an auger is placed within the outer conductor casing in order to push material out of the way while simultaneously advancing the outer conductor casing forward. This provides an ability to increase the diameter of the outer conductor casing and thus increase the diameter of the packed gravel within the outer conductor casing, leading to a higher flow rate of water through the well. The outer conductor casing 104 determines the diameter of the borehole. The borehole may be drilled with a diameter of Y inches and at angle X° with a linear length of N ft.

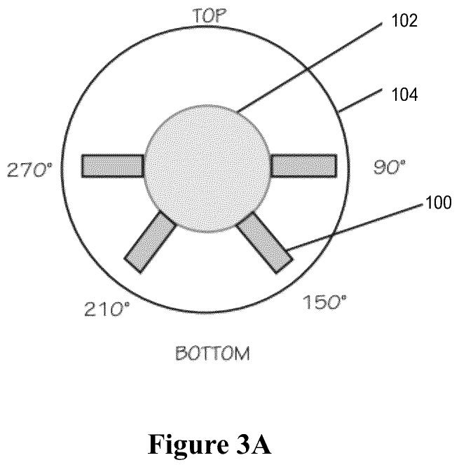

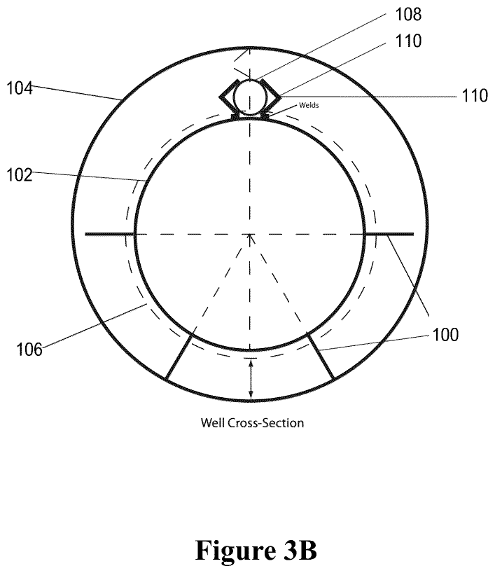

FIG. 3A-B shows cross-sectional views of the casing and borehole. In accordance with the preferred embodiment of the present invention, the centralizers 100 are spaced evenly around a steel wall screen and well casing 102 within the outer conductor casing 104. The terms “screen” and “filter” are used generally herein and are meant to include and cover all types of similar structures commonly used for the purpose of filtering or screening out unwanted debris, sediment, contaminants, etc. while still allowing a desired liquid, for example water, to flow through. In one embodiment, the centralizers 100 are located in increments of 60° around the wall screen and well casing 102. In order to fill the outer conductor casing 104 with the gravel pack 114, a tremie pipe 108 may be employed. The tremie pipe 108 may have additional iron angle tremie guides 110 for stabilization, which may be welded to the steel wall screen and well casing 102. The outer conductor casing 104 and the well casing 102 are shown in FIG. 3B. The centralizers 100 are accordingly located between the well casing 102 and the steel wall screen.

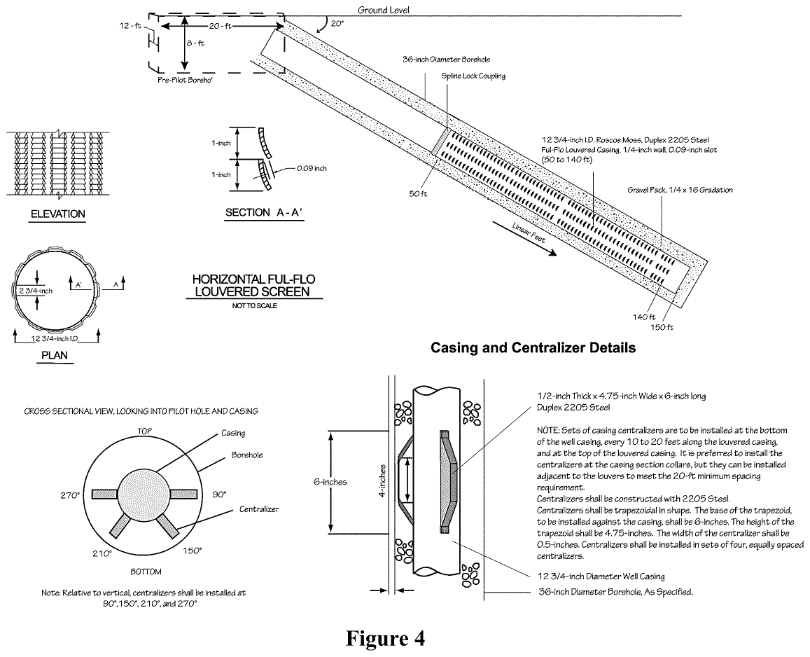

FIG. 4 is a diagram of the present invention. In accordance with the preferred embodiment, the well is drilled at an angle from ground level into a pre-specified subterranean zone. The louvered casing extends into the ground at angle. The louvers end before the end of the louvered casing. The outer conductor casing is filled with the gravel pack, which surrounds the louvered casing and the well casing. In the preferred embodiment, the well pulls ground water from the surrounding area through the louvered casing. An additional screen within the louvered casing filters out small sediment and contaminants. The present invention provides an increased flow rate compared to traditional methods by combining drilling techniques wherein an auger is placed within the outer conductor casing in order to push material out of the way while simultaneously advancing the outer conductor casing forward. This provides an ability to increase the diameter of the outer conductor casing and thus increase the diameter of the packed gravel within the outer conductor casing, leading to a higher flow rate of water through the well.

In accordance with the preferred embodiment, the present invention's innovative diagonal design maximizes water access by extending the well screen horizontally within the aquifer. Once aquifer dimensions are established, the slant wells are engineered for optimal efficiency, with adjustable angles ranging from 5 to 35 degrees to perfectly suit each unique site. Before installation, the site is evaluated by using electrical resistivity studies to determine if the sub surface conditions will work for the slant wells. If slant wells are not viable in the tested location, the present invention's slant wells can be designed and built to be directionally drilled, with open intakes that also mitigate environmental impacts.

The present invention is a long-term sustainable solution for reliable water extraction. In accordance with the preferred embodiment, the slant wells provide efficient, intense weather-resistant water access. Positioned within the water table underneath the ocean floor, the slant wells tap into a virtually infinite water source. The present invention's process enables the installation of a large volume filter pack around the well screen, ensuring long-term performance. The angled drilling allows the well casing to be positioned further from the shoreline, significantly reducing the risk of exposure or damage during major storm events.

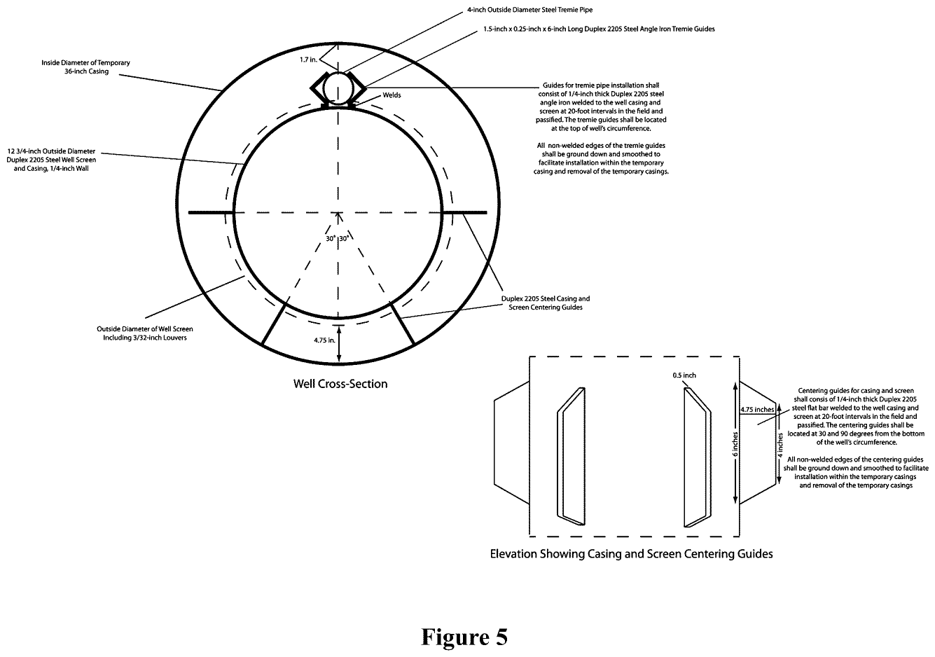

FIG. 5 is a diagram of the well cross section of present invention. In accordance with the preferred embodiment, the well cross section of the present invention, as shown in FIG. 5, the centralizers are spaced evenly around a steel wall screen and well casing within the outer conductor casing. The terms “screen” and “filter” are used generally herein and are meant to include and cover all types of similar structures commonly used for the purpose of filtering or screening out unwanted debris, sediment, contaminants, etc. while still allowing a desired liquid, for example water, to flow through. In one embodiment, the centralizers are located in increments of 60 degrees around the wall screen and well casing. In order to fill the outer conductor casing with the gravel pack, a tremie pipe may be employed. The tremie pipe may have additional iron angle tremie guides for stabilization, which may be welded to the steel wall screen and well casing. The outer conductor casing determines the diameter of the borehole. The centralizers are accordingly located between the well casing and the steel wall screen.

Sets of casing centralizers are installed at the bottom of the well casing at a desired spacing, for example every 10-20 feet, along the louvered casing and at the top of the louvered casing. The centralizers should be installed at the casing section collars but may be installed adjacent to the louvers in alternative embodiments. The preferred material used for the centralizers is 2205 steel, though the present invention contemplates the use of other similar materials. Centralizers should be trapezoidal in shape, where the base of the trapezoid is installed against the well casing. In the preferred embodiment, centralizers are installed in sets of four and are equally spaced. Centralizers should be evenly spaced around the well casing as well as evenly along the well casing. For example, and not by way of limitation, centralizers may be located every 10-20 ft along the well casing, and every 60 degrees around the circumference of the well casing.

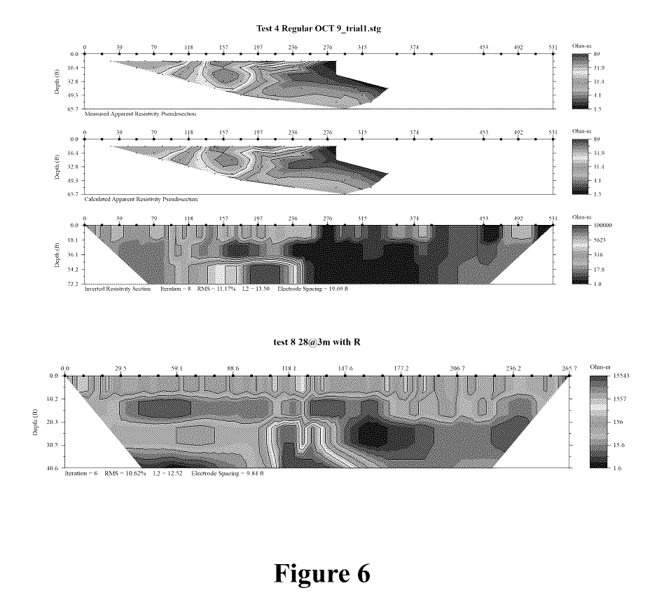

FIG. 6 is a diagram of the electrical resistivity survey results of the present invention. Before installation, the site is evaluated by using electrical resistivity studies to determine if the sub surface conditions will work for the slant wells. If slant wells are not viable in the tested location, the present invention's slant wells can be designed and built to be directionally drilled, with open intakes that also mitigate environmental impacts.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

1. A system for drilling a slant well comprising:
an inner well casing with openings installed wherein an end of said inner well casing extends beneath a water source;
a removable outer conductor casing installed surrounding said inner well casing so that a hollow cavity is formed between said inner well casing and said outer conductor casing;
gravel wherein said gravel is inserted into said hollow cavity and wherein said gravel is sufficient to enable water filtration through said gravel;
a column of gravel formed around said inner well casing and within said removable outer conductor casing; and
wherein an auger contacting said gravel is inserted within said removable outer conductor casing so that a diameter of said column of gravel expands so as to maximize water flow rate through said slant well.
